(19) United States
(12) Patent Application Publication
(10) Pub. No.: US 2009/0141183 A1
(43) Pub. Date: Jun. 4, 2009

(54) Active Splitter Device and Method Using Diplexed Front End

(76) Inventors: Clint Alan Ecoff, Indianapolis, IN (US); Michael Anthony Pugel, Noblesville, IN (US)

Correspondence Address: Robert D. Shedd;Thomson Licensing LLC, 2 Independence Way, PRINCETON, NJ, 08543-5312, US

(21) Appl. No.: 12/226,093

(22) PCT Filed: Apr. 12, 2006
(86) PCT No.: PCT/US06/13745

§ 371 Date: Oct. 7, 2008

(51) Int. Cl. H04N 5/50; H04L 5/00; H04B 1/16

(52) U.S. Cl. 348/731; 370/297; 455/341; 348/E05.097

(57) ABSTRACT

A method and apparatus is presented for actively signal splitting an RF signal. Specifically, the RF signal is frequency-separated to generate a first signal including a first set of frequencies and a second signal including a second set of frequencies. The first and second signals are independently amplified to generate first and second amplified signals, respectively. The first and second amplified signals are then combined to generate a recombined signal. The recombined signal is divided to generate first and second splitter output signals.

### FIELD OF THE INVENTION

The present invention relates Radio Frequency communications and, in particular, to an apparatus and method for splitting a Radio Frequency information signal.

### BACKGROUND OF THE INVENTION

Radio-frequency (RF) communication has become ubiquitous in recent years, and the many sources of RF signals have created a congested signal environment in many areas of the United States and abroad. Simultaneously, the advent of digital communications technologies has imposed stringent requirements on characteristics of the received signal, such as noise, sensitivity, and dynamic range. For example, digital television is one digital communications technology likely to require specific signal characteristics at the receiver.

As digital television increases in popularity, users are likely to demand improvements in performance and convenience to accompany the significant investment required to switch from analog to digital television equipment. For example, users are likely to expect reception of television signals virtually free from interference in addition to convenient integration of additional components such as set top box (STB) devices, personal video recorders (PVR), high-definition (HD) receivers, etc.

This combination of performance requirements and congestion poses significant problems for makers of electronic devices designed to enhance user convenience. For example, users often wish to employ a plurality of devices capable of receiving television signals, such as one or more television sets, personal video recorders (PVR), video-ready receivers, etc. Since many users only own a single antenna or other reception device, a device to split the signal is needed that does not degrade signal characteristics to levels below threshold requirements.

Conventional signal splitting solutions have focused on power amplification of the incoming signal. When an incoming signal of a given power is split into two resulting signals, each of the two resulting signals can have no more than one-half the power of the original incoming signal. This decrease in power at the splitter output is known as insertion loss. If a power amplifier is used to increase the power of the incoming signal prior to the split, each of the two resulting signals will accordingly have increased power, thereby reducing or overcoming the insertion loss caused by the split.

FIG. 1 shows a typical Conventional splitter of this type. An incoming signal from splitter input 101 is amplified by amplifier 102 prior to entering a transformer or balun 103. The transformer or balun 103 employs a well-known circuit structure commonly employing adjacent coils to produce two resulting signals, which are coupled to respective splitter outputs 104 and 105.

Conventional splitters of the type illustrated in FIG. 1 exhibit a number of disadvantages in practice. For instance, amplifier 102 increases the gain of signals across the entire range of frequencies of the incoming signal. Such amplification increases the risk that intermodulation distortion effects may degrade or prevent reception of the incoming signal. Intermodulation distortion is related to interference between signals, sometimes resulting in undesired signals in the frequency band of interest. For example, where a first signal of frequency f1 interferes with a second signal of frequency f2, second-order intermodulation distortion can appear at frequencies f3=f1+f2 and f4=f1−f2, third order intermodulation distortion can appear at frequencies f5=2*f1+f2; f6=2*f1−f2; f7=2*f2+f1; f8=2*f2−f1; and so on for higher-order intermodulation distortion effects.

The undesired effects of intermodulation distortion can be minimized through the use of differential circuit arrangements, special amplifiers, and other carefully selected components. However, components of this type can be relatively expensive, impose significant complexity, and increase costs beyond practical limits.

Therefore, it is desirable to provide an apparatus and method for signal splitting an RF signal that reduces or overcomes insertion loss while simultaneously avoiding intermodulation distortion effects. It is also desirable to provide such an apparatus and method operational with digital television systems in stringent terrestrial signal environments, producing signals showing acceptable noise, sensitivity, and dynamic range performance at a reasonably low cost.

### SUMMARY OF THE INVENTION

The present invention is directed to a method and apparatus for actively splitting an RF signal. Specifically, the method includes separating at least one RF signal to generate a first signal including a first set of frequencies and a second signal including a second set of frequencies. The first signal is amplified to generate an amplified first signal. The second signal is amplified to generate an amplified second signal. The amplified first signal and the amplified second signal are combined to generate a recombined signal including a third set of frequencies that substantially includes the first set of frequencies and the second set of frequencies. The recombined signal is divided to generate a first output signal substantially including the third set of frequencies and a second output signal substantially including the third set of frequencies.

The apparatus of the present invention is directed to an active signal splitter, including a signal separator configured to receive at least one input signal. The signal separator has a first output for conveying a first separated signal and a second output for conveying a second separated signal. A first amplifier is coupled to receive the first separated signal and has a first amplifier output for conveying a first amplified separated signal. A second amplifier is coupled to receive the second separated signal and has a second amplifier output for conveying a second amplified separated signal. A signal combiner is coupled to receive the first and second amplified separated signals and has a signal combiner output for conveying a recombined signal. A signal divider is coupled to receive the recombined signal and has a first signal divider output for conveying a first splitter output signal and a second signal divider output for conveying a second splitter output signal.

The signal separator may include a diplexer, diplex filter, or other device for separating the input signal into first and second separated signals of differing frequencies, in which case the signal combiner may include a diplexer, diplex filter, or other device for accomplishing the reverse of the signal separator. The first and second amplifiers may include low-noise amplifiers (LNA) for increasing signal gain without significantly degrading noise figure or sensitivity. The signal divider may include a passive transformer or balun. This combination of components, when employed in the configuration of the present invention, substantially avoids intermodulation distortion effects in a terrestrial reception signal environment and may be produced at a reasonable cost.

### BRIEF DESCRIPTION OF THE DRAWINGS

In the drawings:

FIG. 1 (Conventional) is a simplified block diagram illustrating an exemplary splitting device known in the art;

FIG. 2 is a simplified block diagram illustrating an exemplary active splitter apparatus in accordance with the present invention;

FIG. 3 is a simplified block diagram illustrating an exemplary active splitter apparatus in accordance with an alternative embodiment of the present invention;

FIG. 4 is a flow diagram illustrating an exemplary method of splitting a signal in accordance with the present invention; and

FIG. 5 is a pictorial block diagram illustrating an exemplary system employing an active splitter constructed in accordance with the present invention.

### DETAILED DESCRIPTION

The following discussion of the apparatus and method for splitting an RF signal will help illuminate the features and advantages of the present invention, including its ease of formation using conventional techniques of constructing electronic devices and circuits which are well known in the art.

In the following discussion, the singular term “signal” and plural term “signals” are used interchangeably and are to be understood as including analog or digital information, at a single frequency or a plurality of frequencies, and may or may not include coding, modulation, sideband information, or other features of signals or waveforms well known in the art. Furthermore, when reference is made to a “receiver,” “transmitter,” “output,” or “input,” previous process steps may have been utilized to form signals or waveforms compatible with these features.

In addition, no particular order is required for the method steps described below, with the exception of those logically requiring the results of prior steps, for example recombination of the first and second amplified signals logically requires the prior separation into first and second signals. Otherwise, enumerated steps are provided below in an exemplary order which may be altered, for instance the several amplification steps may be rearranged or performed simultaneously as is well known in the art.

An exemplary embodiment of the invention will now be described with reference to FIG. 2. Although the invention will be described using the environment of reception of television signals of terrestrial origin, it should be apparent that the invention may be used in other types of radio-frequency communications systems as well. In contrast to the Conventional scheme described above, exemplary embodiments of the present invention substantially decrease intermodulation distortion effects, preserve acceptable signal characteristics, and reduce cost.

FIG. 2 shows a simplified block diagram representation of an active signal splitter generally designated 200 in accordance with an aspect of the present invention. The active signal splitter 200 includes a signal separator 210, a first amplifier 211, a second amplifier 212, a signal combiner 213, and a signal divider 216.

The signal separator 210 may be a diplexer, diplex filter, multiplexer, or other device for separating an RF input signal into two or more sub-signals each having a subset of the frequencies of the input signal. For example, the signal separator 210 may separate an input terrestrial television signal into a first sub-signal including frequencies greater than approximately 328.6 MHz (i.e., UHF) and a second sub-signal including frequencies less than approximately 328.6 MHz (i.e., VHF).

The first amplifier 211 and the second amplifier 212 may be low-cost, low-noise amplifiers, for example LNAs commonly used in the reception of RF signals using superheterodyne receivers well known in the art. Amplifiers 211 and/or 212 should preferably be physically separate and may each be configured to amplify a particular range of frequencies respectively, for example UHF or VHF frequencies, without producing substantial third order intermodulation distortion effects. Alternatively, amplifiers 211 and 212 may be co-located in a single package configured to permit amplification of the first sub-signal separately and independently of the second sub-signal (e.g., substantially free of intermodulation distortion attributable to simultaneous amplification of UHF and VHF frequencies). Amplifiers 211 and 212 should preferably be configured to minimize degradation of one or more particular signal characteristics such as noise figure, sensitivity, and dynamic range. The gain provided by amplifiers 211 and 212 may be sufficient to significantly reduce or overcome insertion loss imparted to the input RF signal by active signal splitter 200.

Signal combiner 213 may be a diplexer, diplex filter, multiplexer, or other Device configured to combine the amplified sub-signals from amplifier 211 and amplifier 212. The signal combiner 213 may be structurally similar to and configured to accomplish the reverse of the signal separator 210. For example, an exemplary signal combiner 213 may be configured to combine the first amplified sub-signal including UHF frequencies with the second amplified sub-signal including VHF frequencies to produce a recombined signal including both UHF and VHF frequencies similar to the original RF input signal. Alternatively, it should apparent to one of ordinary skill in the art that signal combiner 213 may be configured to produce a recombined signal including a range of frequencies different from that of the original RF input signal, but substantially including frequencies of the first and second amplified sub-signals in accordance with an aspect of the present invention.

Signal divider 216 may be a transformer, balun, or other passive power splitter well known in the art configured to accomplish division of the recombined signal into two splitter output signals. Each of the splitter output signals preferably include substantially all of the frequencies of the recombined signal, and thus substantially all of the frequencies of the original RF input signal. Alternatively, it should apparent to one of ordinary skill in the art that each of the splitter output signals may include a range of frequencies different from that of the original RF input signal, but substantially including all frequencies of the recombined signal in accordance with the present invention.

In operation, the active signal splitter 200 receives an RF input signal at input coupler 201 and conveys two splitter output signals of substantially equal power at output couplers 204 and 205. Because the signal separator 210 produces frequency-separated sub-signals which are independently amplified in separate amplifiers 211 and 212, the undesirable signal condition caused by second-order intermodulation distortion during amplification in conventional splitters is not present and thus avoided in accordance with the present invention. One of skill in the art will appreciate that in the United States, VHF television operates at 54-217 MHz and UHF television operates at 470-801 MHz. Accordingly, other “split points” are possible within the scope of the invention.

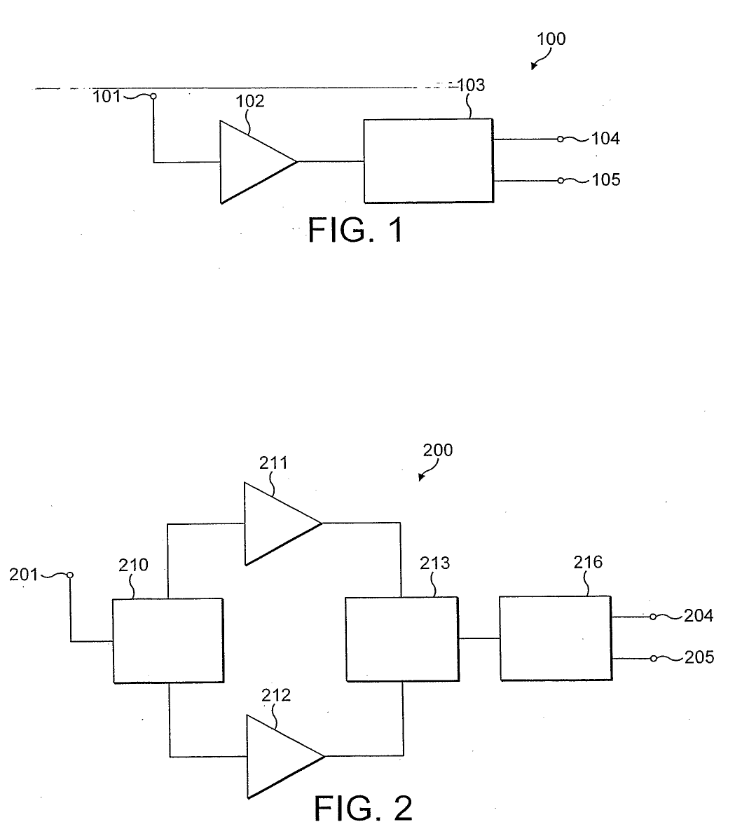

For example, for a U.S. terrestrial television input signal including channel 13 VHF at 211.25 MHz and channel 14 UHF at 471.25 MHz, simultaneous amplification across the full range of input frequencies practiced in Conventional splitters of the type illustrated in FIG. 1 may produce a second order intermodulation distortion effect at 682.50 MHz (i.e., 682.50 MHz=211.25 MHz+471.25 MHz) which is in the frequency range of channel 49 UHF (e.g., channel 49 UHF is assigned to frequency range 680 MHz to 686 MHz), and therefore may disrupt or prevent reception of channel 49 UHF. Using the active signal splitter 200 in accordance with the present invention, amplification of UHF frequencies in first amplifier 211 is performed separately and independently of amplification of VHF frequencies in second amplifier 212, thereby avoiding second order intermodulation distortion effects of the type described. It should be readily apparent to one of ordinary skill in the art that aspects of the present invention are not limited to separating UHF from VHF frequencies, and thus many different frequency separation schemes may be chosen with similar beneficial effect.

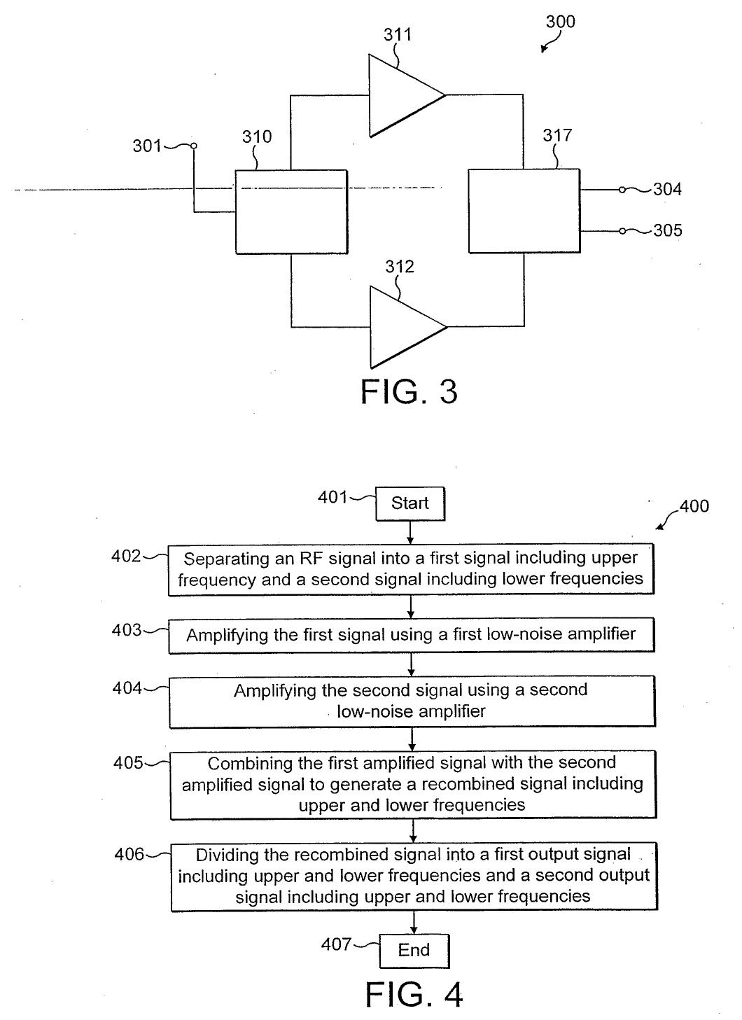

FIG. 3 shows a simplified block diagram representation of an alternate embodiment of an active signal splitter generally designated 300 in accordance with an aspect of the present invention. The active signal splitter 300 includes a signal separator 310, a first amplifier 311, a second amplifier 312, and an integrated signal combiner and divider 317. Signal separator 310, first amplifier 311, and second amplifier 312 may be the same or similar to signal separator 210, first amplifier 211, and second amplifier 212 as described above, respectively, with reference to the active signal splitter 200 illustrated in FIG. 2.

Integrated signal combiner and divider 317 may include discrete components similar to signal combiner 213 and signal divider 216 in an integrated package. For example, integrated signal combiner and divider 317 may include a diplexer, diplex filter, multiplexer, or other device configured to combine the amplified separated signals from amplifier 311 and amplifier 312. The integrated signal combiner and divider 317 may include a signal combiner structurally similar to and configured to accomplish the reverse of the signal separator 310. For example, an exemplary signal combiner and divider 317 may be configured to combine the first amplified sub-signal including UHF frequencies with the second amplified sub-signal including VHF frequencies to produce a recombined signal including both UHF and VHF frequencies. Integrated signal combiner and divider 317 may include a transformer, balun, or other passive power splitter well known in the art configured to accomplish division of the recombined signal into two splitter output signals. Each of the splitter output signals preferably include substantially all of the frequencies of the recombined signal.

Alternatively, integrated signal combiner and divider 317 may include one or more diplexer/transformer circuits. For example, integrated signal combiner and divider 317 may not produce a recombined signal which is subsequently used to generate two splitter output signals. For another example, integrated signal combiner and divider 317 may produce a plurality of recombined signals each of which may be used to generate a single splitter output signal.

In operation, the active signal splitter 300 receives an RF input signal at input coupler 301 and conveys two splitter output signals of substantially equal power at output couplers 304 and 305. Because the signal separator 310 produces frequency-separated sub-signals which are independently amplified in separate amplifiers 311 and 312, the undesirable signal condition caused by second-order intermodulation distortion during amplification in Conventional splitters is not present and thus avoided in accordance with the present invention.

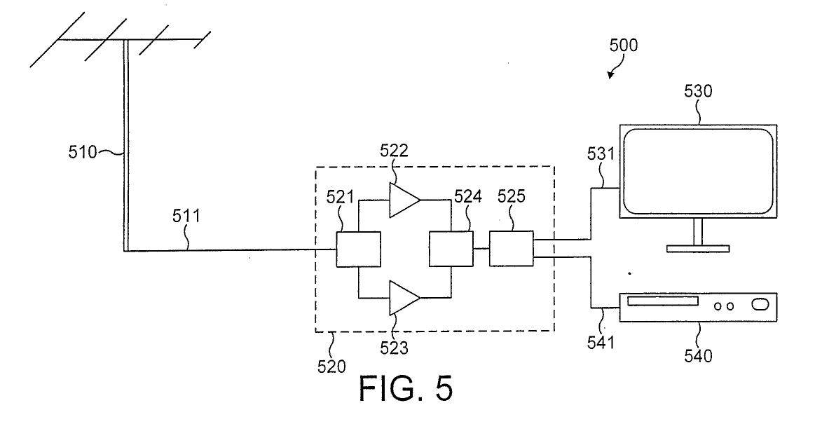

FIG. 4 shows a flow diagram representation of a method of actively splitting an RF signal generally designated 400 in accordance with an aspect of the present invention. The method 400 includes a separating step 402, a first amplifying step 403, a second amplifying step 404, a combining step 405, and a dividing step 406.

The method 400 begins at step 401 and proceeds to step 402 in which an RF input signal is separated into first and second sub-signals. The first sub-signal includes an “upper” set of frequencies (i.e., frequencies greater than a designated separation frequency). The second sub-signal includes a “lower” set of frequencies (i.e., frequencies less than the designated separation frequency). It should be appreciated that the designated separation frequency is not necessarily limited to a single frequency, but may include a range of frequencies such that the upper set of frequencies includes frequencies higher than the range upper limit, and the lower set of frequencies includes frequencies below the range lower limit.

In step 403, the first sub-signal is amplified using a first low-noise amplifier. In step 404, the second sub-signal is amplified using a second low-noise amplifier independently of amplification performed in the first low-noise amplifier. The first and second low-noise amplifiers may be low-cost, low-noise amplifiers similar to amplifiers 211 and/or 212 described above with reference to FIG. 2, for example LNAs commonly used in the reception of RF signals using superheterodyne receivers well known in the art. The first and second low-noise amplifiers may each be configured to amplify a particular range of frequencies respectively, for example UHF or VHF frequencies, without producing substantial third order intermodulation distortion effects. Each of the first and second low-noise amplifiers should preferably be configured to minimize degradation of one or more particular signal characteristics such as noise figure, sensitivity, and dynamic range. The gain provided by the first and second low-noise amplifiers should be sufficient to significantly reduce or overcome insertion loss imparted to the RF input signal during the method 400.

In step 405, the first amplified sub-signal from the first low-noise amplifier is combined with the second amplified sub-signal from the second low-noise amplifier to generate a recombined signal. The recombined signal preferably includes a range of frequencies substantially including both the “upper” frequencies of the first sub-signal and the “lower” frequencies of the second sub-signal, similar to the RF input signal. Alternatively, it should apparent to one of ordinary skill in the art that the recombined signal may include a range of frequencies different from that of the original RF input signal, but substantially including frequencies of both the first and second amplified sub-signals in accordance with the present invention.

In step 406, the recombined signal is divided into first and second splitter output signals of substantially equal power. Step 406 may be accomplished using a transformer, balun, or other passive power splitter well known in the art configured to accomplish division of the recombined signal into two splitter output signals. Each of the splitter output signals preferably include substantially all of the frequencies of the recombined signal, and thus substantially all of the frequencies of the original RF input signal. Alternatively, it should apparent to one of ordinary skill in the art that each of the splitter output signals may include a range of frequencies different from that of the original RF input signal, but substantially including all frequencies of the recombined signal in accordance with an aspect of the present invention. The method then proceeds to step 407, where it ends until another RF input signal is desired to be split.

A television reception system utilizing the active splitter scheme in accordance with an aspect of the present invention is illustrated in FIG. 5. The television reception system 500 includes an antenna 510, at least one active signal splitter 520, and television tuner devices 530 and 540. The antenna 510, for example a conventional rooftop antenna configured to receive terrestrial or over-the-air (OTA) television signals, is coupled to active signal splitter 520 using connector 511. Of course, it should be apparent that antenna 510 is not so limited, and may include one or a plurality of antennas configured for placement at ground level or otherwise and configured to receive analog or digital terrestrial television signals, satellite television signals, cable television signals, or other television signals desired to be received. Antenna 510 may include amplifiers, pre-amplifiers, or other components for television reception as is well known in the art. Connector 511 may be a coaxial cable, fiber optic cable, ribbon cable, high speed data transmission line, or other signal transmission conduit known in the art. The active signal splitter 520 includes signal separator 521, first and second amplifiers 522 and 523, signal combiner 524, and signal divider 525 configured as described above with reference to FIG. 2 and operating in accordance with the present invention. The splitter output signals from active signal splitter 520 are coupled to television tuner devices 530 and 540 via tuner connectors 531 and 541, respectively. Television tuner devices 530 and 540 may include a wide-screen television tuner, personal video recorder with integrated tuner, set top box (STB) tuner, interactive television device configured to permit Internet browsing, or other devices for which signal splitting is desirable.

As illustrated in the preceding discussion and accompanying figures, the method and apparatus of the present invention provide an improvement in the state of the art for signal splitting devices and methods. The present invention provides an active splitter suitable for use in a stringent terrestrial signal environment, utilizing low-cost components and producing splitter output signals showing acceptable sensitivity, dynamic range, and noise figure performance. These improvements result in an active splitter that reduces or overcomes insertion loss while simultaneously avoiding intermodulation distortion effects.

While the invention has been described in detail in connection with the preferred embodiments known at the time, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Accordingly, the invention is not to be seen as limited by the foregoing description, but is only limited by the scope of the appended claims.

1. A method of processing a plurality of signals in a frequency band comprising the steps of:
separating said frequency band into a first set of frequencies and a second set of frequencies,
amplifying said first set of frequencies
amplifying said second set of frequencies
combining said first set of frequencies and said second set of frequencies to generate a recombined signal.

2. The method of claim 1 further comprising the step of dividing said recombined signal to generate a first output signal comprising a third set of frequencies and a second output signal comprising a fourth set of frequencies.

3. The method of claim 1, wherein said first set of frequencies includes frequencies above about 328.6 MHz and said second set of frequencies includes frequencies below about 328.6 MHz.

4. The method of claim 1, wherein said first set of frequencies includes one or more UHF channels.

5. The method of claim 1, wherein said second set of frequencies includes one or more VHF channels.

6. The method of claim 1, wherein at said separating step employs a diplex filter.

7. The method of claim 1, wherein at said combining step employs a diplex filter.

8. The method of claim 1, wherein said separating step employs a diplexer.

9. The method of claim 1, wherein said combining step employs a diplexer.

10. The method of claim 1, wherein said dividing step employs a passive transformer circuit.

11. The method of claim 1, wherein said at least one RF signal includes a plurality of RF signals of terrestrial origin.

12. An apparatus, comprising:
a signal separator configured to receive an RF input signal, said signal separator having a first output for conveying a first separated signal and a second output for conveying a second separated signal;
a first amplifier coupled to receive said first separated signal and having a first amplifier output for conveying a first amplified separated signal;
a second amplifier coupled to receive said second separated signal and having a second amplifier output for conveying a second amplified separated signal; and
a signal combiner coupled to receive said first amplified separated signal and said second amplified separated signal, said signal combiner having a signal combiner output for conveying a recombined signal.

13. The apparatus of claim 12 further comprising a signal divider coupled to receive said recombined signal, said signal divider having a first signal divider output for conveying a first splitter output signal and a second signal divider output for conveying a second splitter output signal.

14. The apparatus of claim 12 wherein said signal separator includes a diplex filter.

15. The apparatus of claim 12 wherein said signal combiner includes a diplexer.

16. The apparatus of claim 12 wherein said signal divider includes a transformer.

17. The apparatus of claim 12 wherein said signal divider includes a balun.

18. The apparatus of claim 12 wherein said first signal divider output is configured to be coupled to a first tuner, and said second signal divider output is configured to be coupled to a second tuner.

19. The apparatus of claim 12 wherein said splitter exhibits intermodulation distortion performance acceptable for use in a terrestrial reception signal environment.

20. A television signal processing system, comprising:
(a) an antenna;
(b) a signal splitter coupled to said antenna, said signal splitter having a first splitter output and a second splitter output;
(c) a first tuner coupled to said first splitter output;
(d) a second tuner coupled to said second splitter output;
(e) wherein said signal splitter includes a diplex filter configured to receive an RF input signal from said antenna, said diplex filter having a first diplex output for conveying an upper-frequency signal and a second diplex output for conveying a lower-frequency signal; a first low-noise amplifier coupled to receive said upper-frequency signal and having a first amplifier output for conveying an amplified upper-frequency signal; a second low-noise amplifier coupled to receive said lower-frequency signal and having a second amplifier output for conveying an amplified lower-frequency signal; a diplexer coupled to receive said amplified upper-frequency signal and said amplified lower-frequency signal, said diplexer having a recombined output for conveying a recombined signal; and a transformer coupled to receive said recombined signal, said transformer conveying a first splitter output signal at said first splitter output and conveying a second splitter output signal at said second splitter output.
